(19) United States
(12) Patent Application Publication
(10) Pub. No.: US 2002/0020414 A1
(43) Pub. Date: Feb. 21, 2002

(54) Multifunctional, multilumen valve assembly, assisted ventilation devices incorporating same, and new methods of resuscitation and ventilation

(76) Inventor: Atsuo F. Fukunaga, Rancho Palos Verdes, CA (US)

Correspondence Address: BRINKS HOFER GILSON & LIONE, P.O. Box 10395, Chicago, IL, 60610, US

(21) Appl. No.: 09/910,205

(22) Filed: Jul. 19, 2001

Related U.S. Application Data
(60) Provisional application No. 60/219,745, filed on Jul. 20, 2000.

(51) Int. Cl. G05B 1/00; A62B 7/00; A62B 9/00; A62B 1/00

(52) U.S. Cl. 128/205.13; 128/205.11

(57) ABSTRACT

A multilumen valve assembly for use in providing resuscitation and assisted ventilation is disclosed. The assembly has a first source conduit, a second source conduit, an exhaust conduit, a one-way valve, and an exhaust valve. In an embodiment, the one-way valve only permits flow from the first source conduit to the second source conduit, and not vice versa. The exhaust valve is operatively connected to the first source conduit and one-way valve. In one embodiment, the exhaust valve is closed when the one-way valve is open, and the exhaust valve is open when the one-way valve is closed. In another embodiment, the exhaust valve remains open unless the pressure in the first source conduit is substantially higher than the pressure in the exhaust conduit, creating a second pressure differential therebetween to inflate a bladder or expand a diaphragm during assisted and/or controlled ventilation. In one embodiment, the second source conduit is coaxial with the exhaust conduit, wherein the valve assembly can be readily connected to and disconnected from various co-axial components, and can be readily converted for use with either co-axial or mono-axial tubing, allowing for patients to use a single mask and filter from the site of an accident or illness, through transport, and various treatment stages and locations, such as in the emergency room, operating room, ICU, and recovery rooms. Methods of using and supplying the various systems that the valve assembly makes possible are disclosed along with a new automated assisted ventilation system incorporating embodiments of the valve assembly.

### RELATED APPLICATION DATA

This application claims priority of U.S. Provisional Patent Application Serial No. 60/219,745, filed Jul. 20, 2000.

### FIELD OF THE INVENTION

This invention relates to devices for use in resuscitating and/or providing assisted and controlled ventilation to patients, and more particularly relates to a multifunctional, multilumen (e.g. co-axial, double lumen, triple lumen) valve assembly that isolates source gases from exhaust gases, assisted ventilation devices incorporating the versatile, multifunctional valve assembly, and methods of resuscitating and providing assisted ventilation to patients using said devices.

### BACKGROUND OF THE INVENTION

Assisted and/or controlled ventilation systems are an essential component of modern medicine. Generally, such systems provide inspiratory gases to a patient from a source of same, such as from a ventilator or an anesthesia machine, and conduct expiratory gases away from the patient. Inspiratory gases are conducted through a different conduit from the expiratory gases and thus at least two conduits are required. With reference to U.S. Pat. No. 4,265,235, to Fukunaga, a unilimb device of universal application for use in different types of breathing systems is described which provides many advantages over prior art systems. The Fukunaga device, sold as the UNIVERSAL F® by King Systems Corporation of Noblesville, Ind., U.S.A., utilizes a space saving co-axial, or tube within a tube, design to provide inspiratory gases and remove expiratory gases. Numerous advantages flow from this arrangement, such as a reduction in the size of the breathing apparatus connected to a patient. Further, the device acts as an artificial nose since expired gases warm and maintain humidity of the inspired gases as the two opposing flows are countercurrent in the unilimb device.

With reference to U.S. Pat. No. 5,778,872, to Fukunaga et al., a new concept of detaching a proximal terminal from the unilimb respiratory conduit (e.g., double lumen, coaxial, monolumen, or multiple lumen, incorporated in a single limb) was introduced, and devices are disclosed. One of the embodiments described in the above mentioned patent is now sold as the F2™ or UNIVERSAL F2® by King Systems Corporation of Noblesville, Ind., U.S.A., which have revolutionized artificial ventilation systems and methods of providing assisted ventilation. The F2™ system provides for safe and ready attachment and detachment of co-axial system components. This permits more efficient placement and utilization of other breathing circuit components, improves system performance, and yet reduces medical waste and costs. For more information about the F2™ technology, one may contact King Systems Corporation. For further information on breathing systems, and anesthetic and assisted ventilation techniques, see U.S. Pat. Nos. 3,556,097, 3,856,051, 4,007,737, 4,188,946, 4,463,755, 4,232,667, 5,284,160, Austrian Patent No. 93,941, Dorsch, J. A., and Dorsch, S. E., Understanding Anesthesia Equipment: Construction, Care And Complications Williams & Wilkins Co., Baltimore (1974), and Andrews, J. J., “Inhaled Anesthetic Delivery Systems,” in Anesthesia, 4^{th} Ed. Miller, Ronald, M. D., Editor, Churchill Livingstone, Inc., N.Y. (1986). The text of all documents referenced herein, including documents referenced within referenced documents, is hereby incorporated by reference as if same were reproduced in full below.

While the UNIVERSAL F® and F2™ devices have made substantial improvements to assisted ventilation methods and systems, their use has been limited to operating room type environments, or to stable or fixed ICU type environments where patients are provided assisted ventilation for a prolonged period of time. As used herein, the term “assisted ventilation” shall also incorporate “controlled ventilation” in both acute and chronic environments. It is desired that the benefits of co-axial assisted ventilation be utilized in all aspects of assisted ventilation and in all locations and situations—during resuscitation of a non-breathing patient by a rescuer at the point of rescue, during transport with assisted mechanical ventilation, in an emergency room, in an operating room environment, in an ICU, and during postoperative recovery. It is desired that a single apparatus, or a set of components forming same, be attached to a patient at the initial point of care (accident scene, home, office, clinics, hospital ward, etc.) and stay with the patient through transport and subsequent phases and locations of care by ready attachment of the apparatus to and its detachment from various assisted ventilation systems as needed.

A common resuscitation technique for patients who have stopped breathing (i.e., patients that have ceased natural or spontaneous breathing), is to provide mouth-to-mouth resuscitation. Mouth-to-mouth resuscitation suffers from many drawbacks, including cross-contamination between the rescuer and the patient, and poor control. Various systems have been developed to alleviate the need for the rescuer to provide direct mouth-to-mouth resuscitation. Companies such as Hudson RCI® provide devices having a mask, an isolation valve, filter, and mouthpiece; the mask is applied over the patient's nose and mouth, and the rescuer blows into the mouthpiece to resuscitate the patient or to assist ventilation. The rescuer's air passes through the filter into the mask. A one-way valve is provided in the mask or filter housing to divert the patient's exhaled air away from the rescuer.

Hudson RCI® also provides a Lifesaver® disposable resuscitator. The resuscitator eliminates the need for a rescuer to provide “mouth-to-mask” ventilation via the provision of a resuscitation bag, which acts as a bellows to provide air to the patient through a mask connected thereto. The resuscitation devices disclosed above are frequently disposed of after a single use due to contamination by patient expired gases. This is expensive and increases medical waste. Additional information on disposable resuscitators and mechanical resuscitators can be found in U.S. Pat. No. 5,803,074 to Pope, U.S. Pat. No. 5,163,424 to Kohnke, U.S. Des. Pat. No. 321,418, to Dolida et al., U.S. Pat. No. 5,791,340 to Schleufe et al., U.S. Pat. No. 5,427,091 to Phillips, U.S. Pat. No. 5,009,226 to Holt, U.S. Pat. No. 5,823,184 to Gross, U.S. Pat. Nos. 5,722,391 and 5,894,839 to Rosenkoetter et al., U.S. Pat. No. 5,359,998 to Lloyd, and product information associated with devices sold by Gibeck, Inc. of Indianapolis, Ind., 46236 USA, for example, Dryden® disposable resuscitation bags and accessories, devices provided by SIMS Portex, Inc., of Ft. Meyers, Fla., 33905 USA, such as the First Response™ manual resuscitator, including product literature including that with document codes 008103F, Single Use #205-5599-300 2/98, and Ambubags sold by Ambu Inc., Maryland.

Certain prior art assisted ventilation devices incorporate a non-rebreathing valve. For example, U.S. Pat. No. 3,036,584 to Lee describes a non-rebreathing valve in which a common exhaust/source conduit for providing and exhausting air from and to a patient is in communication with a conduit providing a source of inspiratory gases through a one-way valve. The one-way valve permits inspiratory gases to flow to the patient when a sufficient, predetermined pressure differential exists between the source (proximal) side of the valve and the patient (distal) side of the valve. Thus, if the patient is spontaneously breathing, during the patient's inspiratory phase, the pressure on the patient's side of the valve is reduced with respect to the pressure on the source side of the one-way valve, causing the one-way valve to open upon the existence of a sufficiently great pressure differential. The device incorporates an exhaust valve in the wall of the common exhaust/source conduit. The exhaust valve is connected to the gas source conduit via a shunt or by-pass conduit; when sufficient pressure exists in the source conduit to force open the one-way valve sufficient pressure also exists in the by-pass conduit to inflate a bladder or expand a diaphragm in the exhaust valve, thereby closing or sealing the opening for exhaust gases in the common conduit. Thus, the patient only inhales gases from the source conduit. When the patient exhales, or when the expiratory phase of the ventilatory cycle occurs, the pressure in the common conduit is greater than the pressure in the source conduit causing the one-way valve to close. The reduced pressure in the source and by-pass conduits permits the diaphragm in the exhaust valve to open or deflate, thus permitting patient expiratory gases to exhaust from the opening in the common conduit. This device provides for isolation of source gases from exhaust gases proximal of the one-way valve, but not distally thereof. In order to prevent contamination of the valve from contaminants in the source gases and from a patient, the valve requires filters between the valve and the source gas and between the valve and the patient.

Prior art resuscitation and assisted ventilation devices cannot be continuously used from an emergency medicine situation, such as the scene of an accident or illness, through an emergency room (ER), operation/critical care situation, and through the ICU and/or recovery room and ward environments. Further, prior art resuscitation devices cannot be used, for example, with the improved co-axial assisted and controlled ventilation systems made possible by the UNIVERSAL F® and UNIVERSAL F2® sold by King Systems Corporation of Noblesville, Ind. Thus, there remains a need for improved resuscitation and assisted ventilation devices that are versatile, simple to use, and which can be integrated into a variety of assisted ventilation or resuscitation modes. For example, it is greatly desired to have a resuscitation device and conduit which can be readily attached and detached to a rescuer's mouthpiece and/or a patient's airway device, such as an orolaryngeal airway tube, a laryngeal mask, or an endotracheal tube or mask, for providing mouth-to-mask ventilation, a breathing bag, a machine-controlled ventilation device, such as those that may be in an ambulance, and to an assisted ventilation system such as that used in an operating room, an ICU and/or recovery room. Thus, it is desired to have a system that is multi-functional and can be seamlessly integrated and used for all phases of patient care involving resuscitation and/or assisted ventilation, whether the patient is at the scene of an accident or where an illness or injury first strikes, is in a stationary location such as a hospital, or being transported.

### SUMMARY OF THE INVENTION

In one aspect, the present invention involves a novel multilumen valve assembly having a first source or proximal conduit, a double lumen (e.g.,co-axial) distal conduit having a second source conduit and an exhaust conduit, a one-way valve, and an exhaust valve. In an embodiment, at least a portion of the second source conduit is contained within the exhaust conduit. For example, a portion of the second source conduit may be co-axial with the exhaust conduit. The term co-axial refers to the relationship of two or more tubes, wherein at least one tube is contained within another. The inner tube does not necessarily need to have its center axially aligned with that of the outer tube. However, in a preferred embodiment, the alignment of the distal end of the inner and outer tubes will match the alignment of a corresponding connecting multilumen conduit. For example, if the inner and outer tubes share a common center axis at their distal end, they would more readily connect to a dual lumen conduit of like configuration (i.e., co-axial). In another embodiment, the second source conduit does not project into the exhaust conduit, although at least a portion of the exhaust conduit and second source conduit may share a common wall, or at least a portion of the wall of the second source conduit and exhaust conduit may be connected.

The one-way valve only permits flow from the first source conduit to the second source conduit, and not vice versa. The exhaust valve is operatively connected to the first source conduit and one-way valve. In one embodiment, the exhaust valve is closed when the one-way valve is open, and the exhaust valve is open when the one-way valve is closed. For this embodiment, it is to be understood that during the transition from having a closed one-way valve and an open exhaust valve to having an open one-way valve and a closed exhaust valve, and vice versa that these conditions may not be completely mutually exclusive. Thus, for example, the exhaust valve may close shortly before or after the one-way valve opens, and the exhaust valve may open shortly before the one-way valve closes from its open position, and thus the expression “the exhaust valve is closed when the one-way valve is open, and the exhaust valve is open when the one-way valve is closed” is to be interpreted broadly enough to cover the foregoing possibilities.

The second source conduit is isolated from the first source or proximal conduit by the one-way valve. In one embodiment, proximal of the one-way valve is a by-pass conduit that is in fluid communication with an exhaust valve control bladder, diaphragm, flap, balloon or other pressure controlled lever located in an exhaust port within the exhaust conduit wall. Although in a preferred embodiment, the by-pass conduit does not permit gases to exhaust from the first source conduit through the exhaust valve, in an alternative embodiment, gases from the first source conduit may exhaust from the by-pass conduit (also referred to as a shunt), but only to the extent such release does not interfere with the operation and use of the valve assembly. Thus, if a patient is spontaneously breathing, inspiratory gases may flow in a distal direction through the one-way valve from the first source conduit to the inspiratory or second source conduit upon the existence of a sufficient pressure differential between the proximal and distal sides of the one-way valve. In the case of assisted and/or controlled ventilation, sufficient positive pressure proximal of the one-way valve causes inflation of the exhaust valve control bladder (or dilates a diaphragm or pushes a flap) such that the exhaust port in the exhaust conduit is closed. The multilumen (e.g., double lumen, co-axial, tri-lumen) valve assembly of the present invention may also be referred to as an F-Valve™.

In a preferred embodiment, a multiple lumen filter, for example a co-axial filter, having separate flow passageways for inspiratory and expiratory gasses is provided, and is operably connected to the distal ends of the second source and exhaust conduits in the valve assembly housing, such that inspiratory gases pass through a first passageway and first filter element within the co-axial filter, and exhaust gases pass through a second passageway and second filter element within the co-axial filter. Thus, both inspiratory and expiratory gases are filtered, protecting the patient from any contaminants in the source gases, while protecting the valve and any rescuers exposed to expiratory gases from the patient. The co-axial valve assembly may be readily detached from the co-axial filter and the co-axial filter then readily attached to a co-axial fitting on an assisted ventilation device such as those using the UNIVERSAL F® or UNIVERSAL F2® available from King Systems Corporation of Noblesville, Ind.

In an alternative embodiment, the multilumen, for example a double lumen or a co-axial valve assembly may be integrated with a mouthpiece or a breathing bag, or may be readily attachable and detachable to a mouthpiece, a breathing bag or an Ambu bag. Other embodiments of the present invention include kits comprising an F-Valve™, a patient mask, a single or double lumen filter, and a respiratory conduit for connecting the mask to the valve either through a singular or double lumen filter. The kit may also include a breathing bag or a mouthpiece for providing bag-to-mask and mouth-to-mask resuscitation. Kits containing various combinations of components can be distributed to health care providers for use in ambulances, theatres, stadiums, schools, offices, police cars, planes, and trains, as well as in hospitals and clinics. In an alternative embodiment an assisted ventilation system is provided which incorporates the F-Valve™.

The F-Valve™ valve assembly of the present invention is referred to as “non-rebreathing.” However, the term “non-rebreathing” does not mean that a patient operatively connected to an F-Valve™ may not re-breathe a certain amount of expired gases contained within the conduit proximal of the patient and distal of the exhaust valve. Even if rebreathing occurs, the patient will receive gases containing sufficient oxygen because the inspired gases are oxygen enriched and are provided with sufficient flow. Patients requiring ventilation may be in different states, i.e., unconscious and not breathing, breathing naturally or spontaneously, breathing sporadically, and may shift between such states unpredictably. Therefore, there is a need to provide means to easily control and/or adjust breathing in any state. In the present invention, the exhaust valve may function bidirectionally when the patient spontaneously breathes allowing for immediate adjustment to alterations in patient breathing. This is an important safety feature of the present invention because the patient does not have to fight the machine if the patient sporadically or spontaneously breathes during assisted or controlled ventilation. Thus, the “non-rebreathing” valve assemblies and devices incorporating same of the present invention may alternatively be referred to as “partial rebreathing” valves and devices, which can be safely used in assisted and/or spontaneously breathing patients.

In an alternative embodiment, a co-axial embodiment of the multilumen valve of the present invention may be used with a single filter and/or single conduit through the use of a conversion valve or a coupling or adapter. In one aspect, the conversion valve permits inspiratory gases to pass through a first conduit, and exhaust gases to pass back through the distal portion of the first conduit that are then directed through the conversion valve through a shunt therein into an exhaust conduit. In a preferred embodiment the converter valve consists of two operatively connected annular baffles located in the distal end of the exhaust conduit of the co-axial valve assembly. The converter valve is not limited to use with the co-axial valve assembly of the present invention, but may be used to interconnect mono-axial components with co-axial components of other systems.

Each baffle has an inner and outer cylindrical wall, and a distal and a proximal wall. The distal wall of the proximal baffle is apposed to the proximal wall of the distal baffle in a sealed fashion. The inner cylindrical wall of each baffle corresponds in diameter to the outer diameter of at least a portion of the second source conduit in the co-axial valve assembly, with the second source conduit acting as a journal upon which the baffles are substantially sealably mounted, with at least one of the baffles capable of rotation with respect to the other. The outer cylindrical wall of each baffle substantially corresponds in diameter to the internal diameter of the exhaust conduit at the section thereof where the exhaust conduit, baffles, and second source conduit are aligned.

The two baffles are each provided with a plurality of axial vents each extending axially therethrough from an opening in the distal wall to an opening in the proximal wall. By rotation of one baffle with respect to the other, the axial vents in the two baffles may be placed in register such that gases may pass through both baffles via the aligned vents. The axial vents may be placed out of register such that gases may not pass from the vents in the first baffle and then through the second baffle, and since the baffles substantially seal the annular passageway between the second source conduit and the exhaust conduit, co-axial flow distal of the baffles is prohibited when the axial vents in the two baffles are not in register.

In one embodiment, the proximal baffle contains one or more radial vents, each radial vent having an interior port in the inner cylindrical wall of the baffle and a proximal port in the proximal wall of the proximal baffle, such that the vent extends at an oblique angle in a proximal direction with respect to the valve through the proximal baffle. The second source conduit of the coaxial conduit in the co-axial valve has one or more radially spaced exhaust openings, and the proximal baffle is axially aligned with the exhaust openings on the second source conduit such that by rotation of the proximal baffle, the interior port or ports of the radial vents can be placed either in or out of register with the exhaust openings in the wall of the second source conduit. Thus, when the proximal baffle is rotated such that the distal baffle axial vents are in register with the corresponding axial vents in the proximal baffle, gases may pass through the exhaust conduit, however the radial vents in the proximal baffle will be out of alignment with the exhaust openings in the second source conduit. When the proximal baffle is rotated so that the interior ports of the radial vents are in register with the exhaust openings in the second source conduit, the axial vents in the two baffles are not in register blocking co-axial flow distal of the baffles, but gases may pass from the second source conduit distal of the proximal baffle through the proximal baffle and into the exhaust conduit, permitting co-axial flow proximal of the baffles.

In an alternative embodiment, the distal baffle has radial vents and is axially aligned with the exhaust openings in the second source conduit. When the exhaust openings in the second source conduit are in register with the interior ports of the radial vents in the distal baffle and the radial vent proximal ports in the proximal wall of the distal baffle are in register with the axial vents in the proximal baffle, shunted gases from the second source conduit can flow through the radial vents in the distal baffle and through the axial vents of the second baffle into the exhaust conduit. In this way, the co-axial non-rebreathing valve of the present invention can be used with a single inspiratory/expiratory conduit and/or single filter when a co-axial conduit and/or filter is not available.

In an alternative embodiment the F-Valve™ assembly of the present invention is modified to include a sensor to detect and control the opening and closing of the inspiratory gas one-way valve and expiratory gas exhaust valve. A control, which may be electrical, mechanical and/or electromechanical, links the status of the inspiratory one-way valve to a control for the exhaust valve. In an alternative embodiment, the one-way and exhaust valves are controlled by an assisted ventilation machine, with an optional microprocessor control. Thus, a patient's spontaneous breathing may be synchronized with a mechanical ventilator, or a patient's respiration automatically adjusted to provide for a variety of assisted ventilation techniques, such as PEEP, CPAP, etc., and still have the benefits derived from use of a multilumen unilimb_assisted ventilation system.

In a preferred embodiment, an improved assisted ventilation system is provided which incorporates the multilumen valve assembly of the present invention and optionally incorporates a device for linking the operative status of the inspiratory one-way valve with the operative status of the exhaust valve in a controlled and/or pre-determined or programmed fashion. The valve, devices, and systems of the present invention are useful in new methods of resuscitation, spontaneous, as well as assisted ventilation and/or controlled ventilation, and methods of providing equipment for carrying out such methods. The present invention may be better understood by reference to the figures and further detailed description below. As indicated, the invention refers to a multilumen (e.g., double lumen) valve wherein the lumens need not be in a specific size form or configuration, but a coaxial configuration is presented for illustration and as a preferred embodiment.

### DESCRIPTION OF THE FIGURES

FIG. 1 is a partial cross sectional view of a resuscitator device incorporating the new valve assembly of the present invention, and includes flow lines illustrating the build-up of a pressure differential proximally and distally of the one-way valve leading to inflation of a bladder in the exhaust valve.

FIG. 2 illustrates the device of FIG. 1 with flow lines illustrating the passage of fluids through the device upon the opening of the one-way valve.

FIG. 3 illustrates the device of FIG. 1 with flow lines showing the passage of fluids during the exhaust cycle.

FIG. 4a, b and c are partial cross sectional views of devices for providing mouth-to-mask ventilation or resuscitation, which incorporate a one-way valve in a first passageway and an exhaust valve in a second independent passageway in operative connection with the one-way valve.

FIG. 5 is a partial cross sectional view of an assisted ventilation system incorporating an embodiment of the new valve assembly for providing and exhausting gases to a patient.

FIG. 6 is an exploded, perspective, view of a converting valve assembly for permitting use of a co-axial valve assembly such as that shown in FIG. 1 with either a co-axial or mono-axial distal patient conduit.

FIG. 7 is a partial cross sectional view of the converting valve assembly of FIG. 6 in which the proximal and distal baffles are aligned to permit co-axial flow, and better illustrating the alignment of the axial passageways in the two annular baffles shown in FIG. 6.

FIG. 8 illustrates the assembly of FIG. 6 with the proximal baffle rotated such that the axial passageways in the baffles are not in alignment, thus prohibiting co-axial flow.

FIG. 9 is a partial cross sectional illustration of the converting valve assembly of FIG. 8, illustrating that co-axial flow, while blocked distally of the baffles, is made possible proximally of the converting valve assembly when the baffles are in the alignment illustrated.

FIG. 10 is a side elevation view of an alternative embodiment of a co-axial [non-rebreathing] valve assembly of the present invention.

FIG. 11 is a partial cross-sectional view of the valve assembly of FIG. 10.

FIG. 12 is a block diagram of an assisted/controlled ventilation system incorporating the co-axial non-rebreathing valve assembly of the present invention.

FIG. 13 is a plan view of an alternative co-axial valve embodiment, in which a shunt extends between the first inspiratory conduit and a valve in the exhaust conduit, and also shows an end view of a corresponding coaxial conduit that may be connected to the distal end of the second inspiratory conduit and distal end of the exhaust conduit.

FIG. 14 is a plan view of an alternative dual lumen valve embodiment, in which a shunt extends between the first inspiratory conduit and a valve in the exhaust conduit, and also shows an end view of a corresponding dual lumen conduit that may be connected to the distal end of the second inspiratory conduit and distal end of the exhaust conduit.

### DETAILED DESCRIPTION OF THE INVENTION

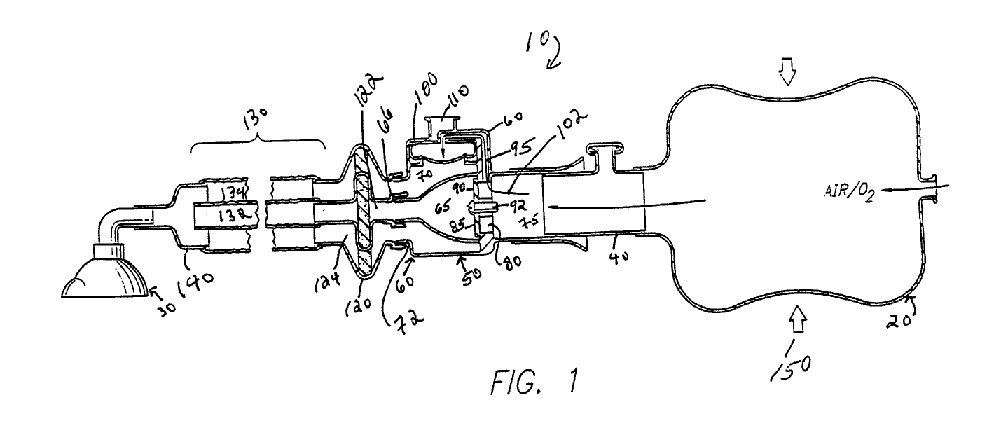

With reference to FIG. 1, a new resuscitator apparatus 10 is illustrated. At the proximal end is provided a breathing bag 20, and at the distal end is provided a patient mask 30. As used herein, proximal shall refer to the end of any device furthest away from the patient or to be aimed away from the patient whereas distal shall mean the patient end of a device or the end of the device to be aimed toward a patient. Breathing bag 20 is connected via a conduit 40 to valve assembly 50. Valve assembly 50 includes a housing 60, which forms an inner passageway or conduit 65 and an outer conduit or passageway 70. A source conduit 75 is located at the proximal end of housing 60. Source conduit 75 may also be referred to as the first source conduit. Inner conduit 65 may also be referred to as the second source conduit or referred to as the common conduit. Outer conduit 70 may also be referred to as the exhaust conduit.

Within housing 60, a passageway 80 is located between source conduit 75 and inner conduit 65. Fluid communication between source conduit 75 and inner conduit 65 via passageway 80 is controlled by a check valve, referred to herein as one-way valve 85. One-way valve 85 includes a flexible barrier 90 held in register with passageway 80 by screw 92. Alternative constructions of one-way valve 85 may also be utilized, such as a spring biased flap, magnetically or electromechanically-controlled screw, etc.

A shunt or passageway 95 in housing 60 provides fluid communication between source conduit 75 and a bladder 100. Bladder 100 is located within exhaust port 110. A flow line 102 illustrates the direction of fluid flow from source conduit 75 to bladder 100. If the pressure in source conduit 75 is greater than the pressure in outer conduit 70, bladder 100 will inflate, and block exhaust port 110. In an embodiment, bladder 100 is inflated sufficiently to block exhaust port 110 only when there is a sufficient pressure differential proximally and distally of one-way valve 85 to open valve 85.

Valve assembly 50 is coupled to a co-axial filter 120. The distal terminus 66 of inner conduit 65 is coupled to the inner conduit 122 of co-axial filter 120. The distal terminus 72 of outer conduit 70 is coupled to the outer conduit 124 of co-axial filter 120. Thus, the co-axial filter ensures that gases flowing from source conduit 75 are filtered prior to administration to a patient, and that gases flowing from a patient to exhaust port 110 are filtered prior to entering housing 60 of the valve assembly.

The distal end of co-axial filter 120 is coupled to a flexible co-axial conduit 130 such that inner conduit 122 of co-axial filter 120 is in fluid communication with inner flexible conduit 132 and outer flexible conduit 134 is placed in fluid communication through outer conduit 124 of co-axial filter 120 with outer conduit 70. A reducing coupling 140 links flexible, co-axial conduit 130 with mask 30.

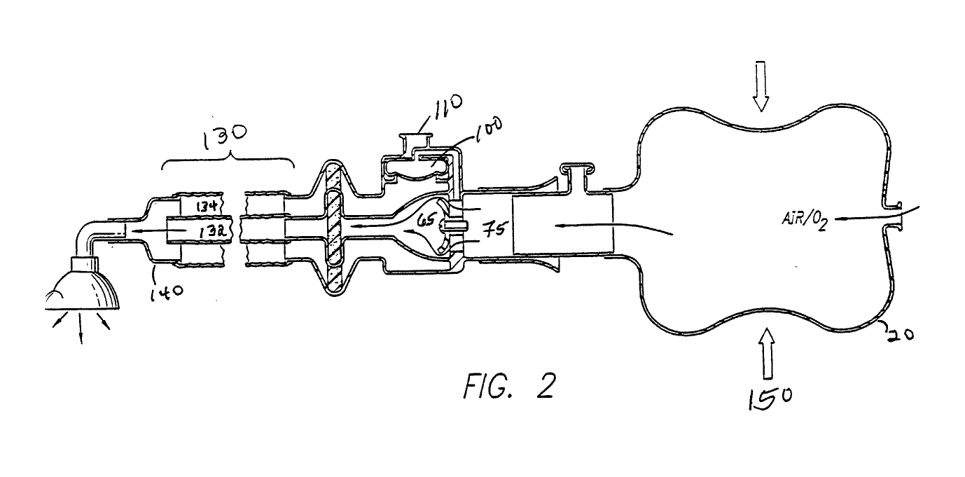

Compression arrows 150 illustrate that by compression of the walls of breathing bag 20 a pressure gradient can be placed between source conduit 75 and inner conduit 65 distal of one-way valve 85. With reference to FIG. 2, pressure arrows 150 are enlarged to illustrate greater pressure being placed upon breathing bag 20, causing a greater pressure gradient between source conduits 75 and inner conduit 65, thus causing the flexible barrier 90 to bend in a distal direction, which permits fluid communication between source conduit 75 and mask 30 through one-way valve 85. Although source conduit 75 is placed in fluid communication with exhaust port 110 via the junction of inner flexible conduit 132 and outer flexible conduit 134 with coupling 140, flow is not permitted through conduit 134 and out of exhaust port 110 due to the inflation of bladder 100 which completely blocks exhaust port 110 when one-way valve 85 is open.

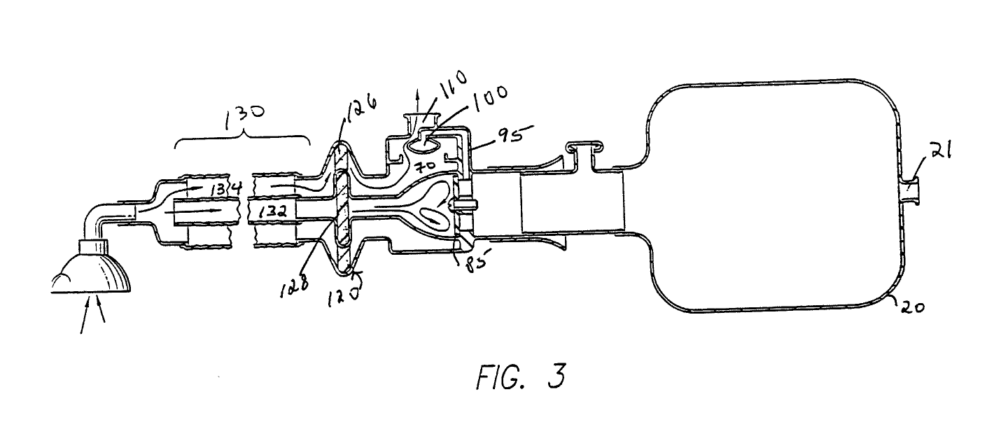

With reference to FIG. 3, breathing bag 20 is preferably made of a resilient material, such that upon release of pressure applied to the bag, the bag returns to its original inflated or decompressed state. Breathing bag 20 draws air via a second one-way valve 21 at its proximal end. When breathing bag 20 is compressed, one-way valve 21 is closed, forcing air into shunt 95 and through one-way valve 85. When the bag is released from a compressed state and reverts to a decompressed state this cause one-way valve 85 to close while also causing bladder 100 to deflate, thus unblocking exhaust port 110. When one-way valve 85 is closed, exhaust gases in inner flexible conduit 132 may not exhaust therethrough, and thus exhaust gases are forced through outer flexible conduit 134, through outer filter 126 of co-axial filter 120, through outer passageway or conduit 70, and out of exhaust port 110. Thus inspiratory gases are filtered through inner filter 128 of co-axial filter 120 and exhaust gases are filtered through outer filter 126.

Using the system illustrated in FIGS. 1-3 a patient may be resuscitated or provided with assisted ventilation while filtering out contaminants from the source gases and filtering out contaminants from the patient's exhaust gases. This system and technique protects the rescuer or healthcare provider from exposure to airborne contaminants and diseases from a patient, such as but not limited to diseases like tuberculosis. Co-axial conduit 130 may be of variable length, and in a preferred embodiment is of sufficient length that the rescuer may monitor the patient while resuscitating and/or providing assisted ventilation to the patient. By extending conduit 130 away from the patient, more room is created near the patient for other procedures, thus a more sterile and safer resuscitation and assisted ventilation apparatus and technique is provided by the present invention.

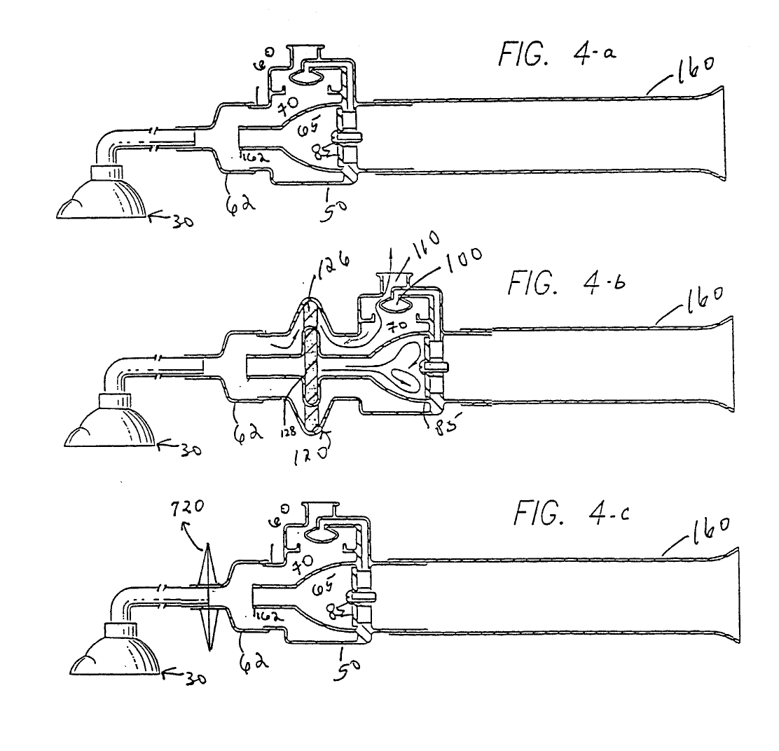

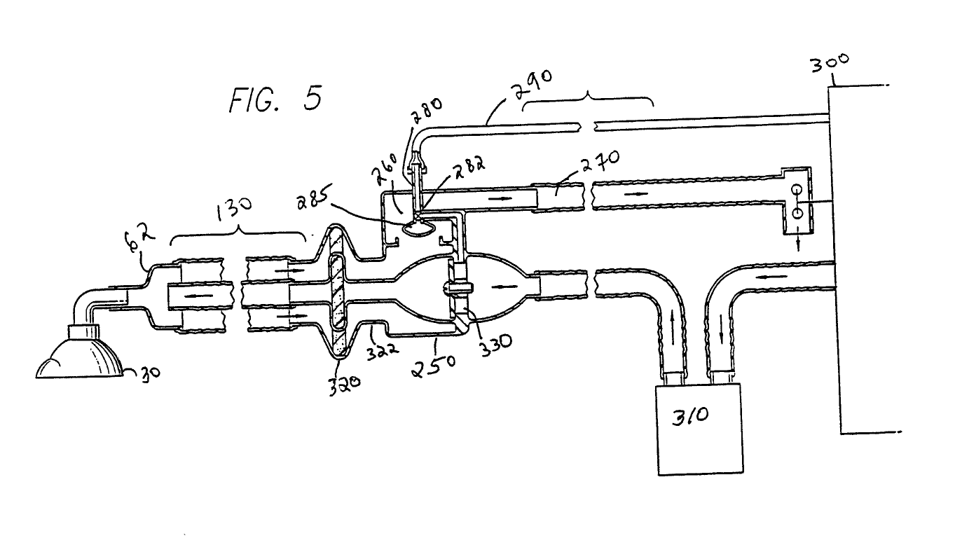

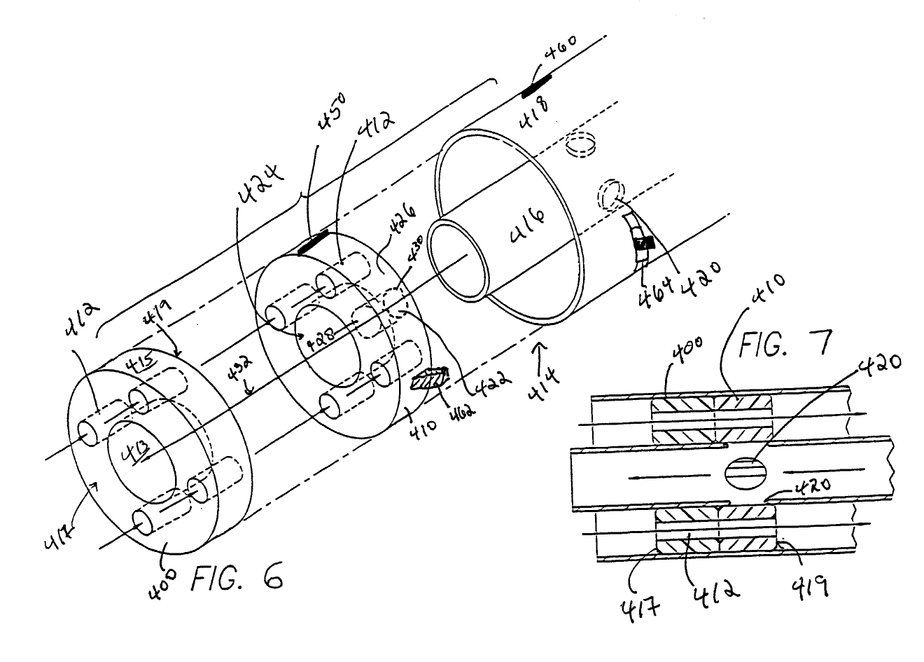

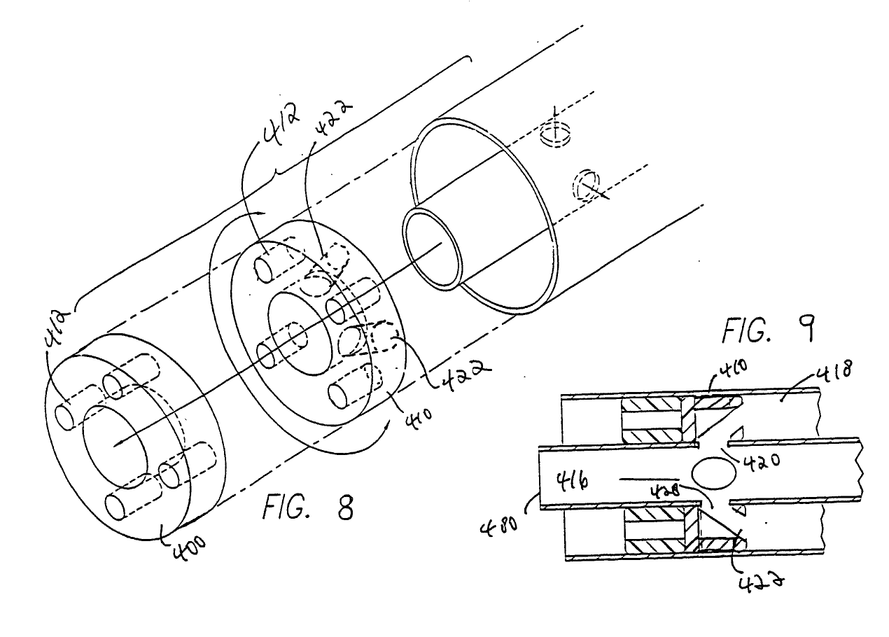

Valve assembly 50 is shown to be detachable from co-axial filter 120 in FIG. 1 whereas it is shown in a unitary device in FIGS. 2 and 3. With reference to FIGS. 4a, b and c, valve assembly 50, conversion (reducing) coupling (cap) 62, and mask 30 are shown connected to a rescuer's mouthpiece 160. In these embodiments the rescuer is protected from patient exhaust gases by one-way valve 85. However, as there is no filter provided in the embodiment illustrated in FIG. 4a, the device can only be utilized for one patient before disposal, and the patient is not protected from contaminants and microorganisms from the rescuer. In an alternative embodiment illustrated in FIG. 4b, co-axial filter 120 may be utilized at the distal end of housing 60, optionally with a co-axial flexible conduit such as that illustrated in FIGS. 1-3. In an alternative embodiment illustrated in FIG. 4c, a mono-axial (single) filter 720 may be utilized at the distal end of coupling 62 with a single conduit operatively connected to a patient device, such as mask 30. When a filter is attached to the distal end of the valve assembly 50, and capable of ready detachment, it may not be necessary to sterilize the valve assembly or to dispose of it after a single use. Thus, in alternative embodiments, filters 120 and 720 are detachably coupled to valve assembly 50, so that it may be reused, in some cases without sterilization.

In one embodiment, the distal end 162 of inner conduit 65 extends distally of the distal end of outer conduit 70. Such an arrangement may be utilized to better insure that co-axial fittings are securely attached. In particular, it is desired that users of the device be assured that the inspiratory gas flow to a patient not be interrupted by a disconnection, and thus, in preferred embodiments, co-axial fittings between components in the present invention will not stay connected unless the inner tubular components are substantially sealably connected.

With reference to FIG. 5 an assisted ventilation system is provided that incorporates valve assembly 250, which is substantially identical to valve 50 illustrated in FIG. 1 with the exception that exhaust port 110 of FIG. 1 is replaced by exhaust port 260. Exhaust port 260 is in fluid communication with an exhaust conduit 270. An expiratory valve 280 is in fluid communication, preferably sealed fluid communication, with exhaust/control line 290. A control mechanism 282 may be in operative connection with a central control device operated via control panel 300. Control mechanism 282 can likewise be modified to only permit inflation of bladder 285 when certain pressure differential conditions are present.

The assisted ventilation system illustrated in FIG. 5 is representative of standard assisted ventilation systems conventionally used in an ICU. For example, a humidifier 310 may be provided, preferably in conjunction with a device for controlling the temperature and humidity of the inspiratory gases. The system of FIG. 5 provides all the benefits of co-axial assisted ventilation, and can be readily integrated with the device of FIG. 4 or the device of FIG. 1 as follows.

With reference to FIGS. 4a-c, following detachment from valve 50, mask 30 and coupling 62 can be readily attached to the distal end of coaxial conduit 130 in the system illustrated in FIG. 5. In the alternative, and with reference to FIG. 5, co-axial filter 320 and coaxial conduit 130 may be detachable from valve 250 at neck 322. Referring to FIG. 1, filter 120 that is coupled to coaxial respiratory conduit 130 that is in turn coupled to mask 30 can be detached from valve 50, and these components can be readily attached to the neck 322 of coaxial valve 250 in the system illustrated in FIG. 5.

Thus, a patient can be supplied with a single mask and co-axial filter setup (optionally with a length of co-axial and/or mono-axial tubing therebetween), such as mask 30, tubing 130, and filter 120, which can be used in multiple phases of treatment. For example, mouth-to-mask resuscitation and/or ventilation may be provided to a patient at any location via connection of the distal end of mouthpiece 160 to the proximal end of valve assembly 50, the distal end of which is connected to the proximal end of filter 120. Mouthpiece 160 may be readily detached from valve assembly 50 to permit ready attachment of the distal end of breathing bag 20 to the proximal end of valve assembly 50 to provide bag-to-mask resuscitation and/or ventilation. In the alternative, the mouthpiece may not be used at all, and a conventional Ambu bag and co-axial valve can be initially used for resuscitation and/or assisted ventilation. The mask and co-axial filter setup initially utilized on the patient can be used in subsequent care of the patient utilizing different assisted/controlled ventilation apparatuses. Depending on the assisted ventilation system utilized in subsequent care of the patient, the valve assembly 50 may be detached from the mouthpiece or breathing bag but kept attached to the proximal end of the filter; the valve assembly can then be utilized to couple the patient to an assisted ventilation system. In the alternative, the valve assembly 50 may be detached from the filter, and reused by the rescuer, while the co-axial filter is utilized to couple the patient to an assisted ventilation system. For transport, the patient may be readily decoupled from the assisted ventilation apparatus, and readily coupled via the valve or filter to another breathing bag or portable ventilator system. An important advantage derived the use of the interchangeable components of the present invention is that minimal or no disturbance of the patient is necessary to switch between modes of resuscitation or assisted ventilation. This is particularly significant where a patient's head or neck are injured, since the mask or airway tube can be left on, and the conduit from the mask may be of sufficient length to provide more uninhibited access to the patient.

Thus, a single mask and/or airway tube and filter can be utilized by a patient at a plurality of locations and with different resuscitation and assisted or controlled ventilation apparatuses.

In a preferred embodiment, a valve assembly, such as assembly 50 in FIG. 1 may be reutilized for emergency medicine while filter 120, conduit 130, and mask 30 (or endotracheal tube) may stay with the patient from the scene of an accident, through the emergency room (ER), the operating room (OR), postanesthesia care unit (PACU), intensive care unit (ICU), and/or the ward. This improves upon the current practice of providing a new set of ventilation components, including airway conduits, at each stage and location of treatment.

With the present invention, for example, by use of a co-axial filter assembly, the same airway conduit 130 and coaxial filter 120 can be utilized for anesthesia in the OR, and can remain with the patient during transport to and in the PACU. The undisturbed airway conduit 130 and coaxial filter 120 can be utilized as a T-piece to provide oxygenation during transport, i.e., no new set of ventilation components is required.

By limiting the number of masks, airway conduits, and attachments utilized by a patient, a substantial reduction in medical costs and wastes are achieved. Further, the ability of the various components to be readily connected and disconnected increases safety, as gaps in patient ventilation are reduced or eliminated. For example, using the components described herein, it is possible to disconnect the patient's airway conduit and filter from one resuscitation or assisted ventilation apparatus and to connect them to a different resuscitation or assisted ventilation apparatus in a few seconds, possibly while the patient is in the expiratory phase of a single respiratory cycle.

By use of a co-axial filter, all components proximal of the filter may be reutilized from patient to patient. When a rescuer's mouthpiece and co-axial valve assembly is used, it may be reused by the rescuer. In an alternative embodiment, a filter is provided at the distal end of the mouthpiece to avoid contamination of the co-axial valve assembly. As one of skill in the art may appreciate, the organization and utilization of the various components with the valve assembly of the present invention may be varied to accommodate the needs of a particular patient.

In a preferred embodiment, kits for use in emergency medicine situations are provided, wherein the co-axial valve assembly 50 is provided along with other components. For example, a first kit may comprise valve assembly 50, a breathing bag 20, and/or a mouthpiece 160. While mouthpiece 160 may only be useful for one particular rescuer to use and reuse, valve assembly 50 and breathing bag 20 may be reused provided appropriate filters, such as filter 120 are utilized. A supply of co-axial filters and other components designed for use by a single patient may be provided in the same kit with a reusable valve assembly 50, patient components, such as filters, co-axial tubing, and masks may be provided in separate kits. While a kit comprising a co-axial valve is described herein, kits incorporating a non-co-axial F-valve™-0 are also envisioned.

Thus, new methods of providing resuscitation and assisted ventilation are provided, wherein a patient in need of respiratory assistance or resuscitation is operatively connected to a mask such as mask 30 to a co-axial circuit and filter such as co-axial filter 120 through a valve such as valve assembly 50 to either a mouth piece 160 or a breathing bag 120, and resuscitation or assisted ventilation provided. At the hospital or other point of care the co-axial circuit and filter may be detached from the valve assembly 50 and connected into a system such as illustrated in FIG. 5. In an alternative embodiment, co-axial filter 320 is semi-permanently installed to an assisted/controlled ventilation machine, to which disposable co-axial respiratory conduit such as conduit 130 may be connected. The purpose of co-axial filter 320 being semi-permanently installed, despite use of disposable co-axial filters being preferred, is to protect the remainder of the permanently installed system from contamination due to human error in not connecting a filter, or leaving the system exposed to ambient conditions when not connected to other system components, such as during transport. Thus, more than one co-axial or multilumen filter may be used.

With reference to FIG. 5, modified assisted ventilation techniques may be practiced with the device by programming control unit 300 to adjust the pressure, amounts, and timing of inspiratory gas flows to one way valve 330 and to independently adjust the timing and duration of the inflation and deflation cycles of bladder 285. Thus, techniques such as PEEP, CPAP, etc. may be practiced while utilizing a multilumen (e.g. co-axial) assisted ventilation system. Further, patient spontaneous breathing may be synchronized with the automated ventilation system. For example, the exhaust valve may further comprise an additional (third) barrier, such as a resilient flap or spring biased flange, which is operatively connected to a seat; the pressure with which the barrier is biased towards the seat can be adjusted for controlling positive end expiratory pressure (PEEP) and continuous positive airway pressure (CPAP). Alternatively, the exhaust valve flapper or stopper can be controlled for these purposes.

With reference to FIG. 6, an axially exploded perspective view of a converter or converting valve is illustrated, which converts the co-axial valve assembly of the present invention for use with a single filter and/or single patient conduit. The converter valve may be adjusted to provide for co-axial flow distal and proximal of the converter valve or to provide for mono-axial flow distal and co-axial flow proximal of the converter valve.

A distal baffle 400 and a proximal baffle 410 are each provided with a plurality of axial passageways or vents 412. Each baffle has an inner cylindrical wall 413 and an outer cylindrical wall 415, which are connected by a distal annular wall 417 and a proximal annular wall 419. The distal terminus 414 of the housing of a valve, such as valve 50 shown in FIG. 1, is distally extended sufficiently to enclose baffles 400 and 410 between an internal conduit 416 and an outer conduit 418 blocking the passageway therebetween. Internal conduit 416 is axially centered with respect to outer conduit 418. Internal conduit 416 is provided with one or more openings 420.

With reference to FIG. 7, openings 420 are axially aligned with proximal baffle 410 such that by rotation of baffle 410 with respect to internal conduit 416, openings 420 may be aligned in register or aligned out of register with radially extending passageways or radial vents 422. Radial vents 422 in proximal baffle 410 extend radially outward in a proximal direction from the inner cylindrical wall 424 of baffle 410 to the proximal annular wall 426 of baffle 410. Each radial vent 422 has an inner port 428 and a proximal port 430, and a passageway that extends at an oblique angle from the inner port to the proximal port.

With reference to FIGS. 8 and 9, proximal baffle 410 has been rotated with respect to distal baffle 400 and conduit 416 such that axial vents 412 in distal baffle 400 are no longer in axial register with axial vents 412 in the proximal baffle 410. Distal wall 417 of proximal baffle 410 is substantially sealably apposed to the proximal wall 419 of distal baffle 400 (i.e., the baffles are pushed against each other), but one baffle may rotate with respect to the other. Referring back to FIGS. 6 and 7, it can be seen that axial vents 412 in baffles 400 and 410 are axially aligned, so that fluid may flow from distal of proximal baffle 400 to proximal of baffle 410 through the aligned axial vents 412; thus co-axial flow is possible proximal and distal of the baffles in this configuration. However, note that in the configuration illustrated in FIGS. 6 and 7, openings 420 are not aligned with ports 428 of radial vents 422.

A detent 450 is located on proximal baffle 410 along with a corresponding catch member 460 on the inner wall of outer conduit 418, such that an audible or tactile indicator is provided of the rotational position of proximal baffle 410 with respect to inner conduit 416. A lever 462 is provided on the outer cylindrical wall of baffle 410 and placed in register with slot 464 to provide a control for rotation of proximal baffle 410. However other means may be provided for controlling rotation of the baffle such as magnets, or an axial control sleeve may be used.

With further reference to FIGS. 8 and 9, openings 420 are placed in register with ports 428 of radial vents 422. In this configuration, co-axial flow distally of the baffles is not permitted, since the axial vents in the two baffles are not aligned, and thus both inspiratory and expiratory gases flow through the proximal end 480 of inner conduit 416. However, expiratory gases may exit inner conduit 416 through openings 420 and flow into outer conduit 418 via radial vents 422 in proximal baffle 410, thus permitting the co-axial valve assembly of the present invention to be used with both co-axial filters and also with single conduit filters.

In an alternative embodiment, proximal baffle 410 is sealably fixed between inner conduit 416 and outer conduit 418, while distal baffle 400 is rotatably mounted upon inner conduit 416 that acts as a journal. Radial vents, such as 422, are present in distal baffle 400 and the inner ports 428 are axially aligned with openings 420 in inner conduit 416 (proximal baffle may optionally have radial vents, the interior port of which is blocked by the outer wall of inner conduit 416, to save on the cost of manufacturing different baffles). By rotating distal baffle 400 with respect to proximal baffle 410, (1) the axial vents may be aligned between the two baffles to permit coaxial flow distal and proximal of the baffles, or (2) the inner ports 428 of the radial vents will be in register with the openings 420 in inner conduit 416, and the proximal ports of the radial vents in the proximal wall of the distal baffle will be in register with the axial vents 412 in the proximal baffle, thereby permitting co-axial flow proximal but not distally of the baffles. In this one embodiment, the proximal baffle may be a solid annular fixed wall with radial arranged openings, so that the radial arranged openings may be alternatively placed in register with the axial vents or with the radial vents of the distal baffle to respectively provide or block co-axial flow distal of the baffles.

A detent and catch, such as detent 450 and catch 460 are utilized to provide a tactile and/or audible sensor of baffle position. A lever or flange may project axially from the distal annular wall of the distal baffle to assist with rotating the baffle. In one embodiment, as a safety feature, two locking catches (not shown) are provided for the detent, such that upon rotating the conversion valve baffle to the desired configuration for co-axial or mono-axial flow, the valve can not be readily adjusted to the alternative configuration.

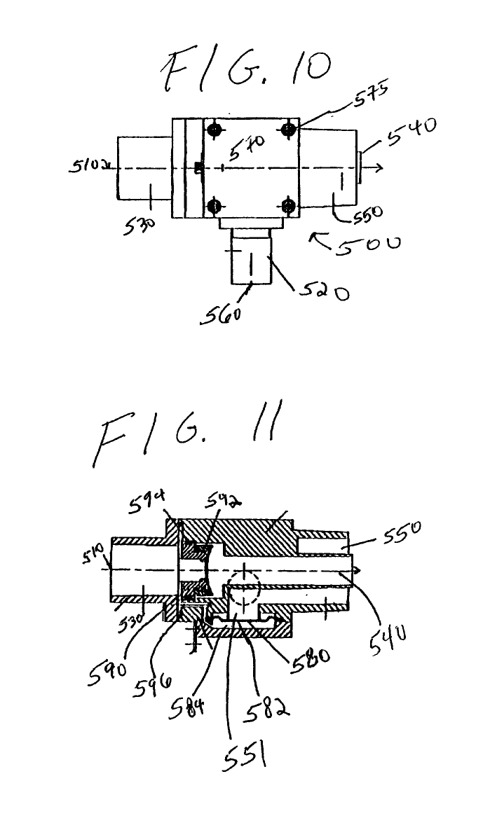

With reference to FIGS. 10 and 11, an alternative construction of the valve assembly 500 of the present invention is illustrated. Source gases flow in the direction shown by arrow 510, such that the distal end of the device is on the right, and the proximal end is at the left. The housing 520 may be of metal, plastic or other suitable material, and includes a first source conduit 530, a second source conduit 540, an external or exhaust conduit 550, and an exhaust port 560. An access plate 570 permits access to the housing interior, and is sealably connected by screws 575.

Flow through exhaust port 560 is controlled by exhaust valve 580. First source conduit 530 is isolated from second source conduit 540 by one-way valve 590. One-way valve 590 has a resilient flap 592 that is biased against a seat 594. Flow through one-way valve 590 is possible when the pressure in first source conduit 530 sufficiently exceeds the pressure in second source conduit 540 to unseat flap 592 from seat 594. Exhaust valve 580 comprises a resilient diaphragm 582, which seals the end of a chamber 584 at the end of a by-pass passageway or shunt 596. By-pass 596 is in fluid connection with first source conduit 530 proximally of one-way valve 590. When a sufficient pressure differential exists between source conduit 530 and exhaust conduit 550, diaphragm 582 presses against and blocks port 551 in exhaust conduit 550.

Although preferred embodiments have been disclosed of a co-axial valve assembly, resuscitation and assisted/controlled ventilation devices incorporating same, kits incorporating same or containing components for use therewith, and new resuscitation and assisted ventilation techniques using these devices and kits, such disclosure has been merely exemplary and various modifications, including a non-coaxial, multilumen valve assembly are within the scope of the present invention.

Further, alternative descriptions and terms may be used, for example: the co-axial valve assembly of the present invention for use in a resuscitation or assisted/controlled ventilation device can be described as comprising: a first source conduit, a second source conduit, and an exhaust conduit, a portion of the second source conduit being located within and being co-axial with said exhaust conduit, an exhaust valve operatively connected to the exhaust conduit, the exhaust valve capable of opening and closing, wherein when the exhaust valve is open fluid may pass from the exhaust conduit through the exhaust valve to exhaust outside of the exhaust conduit, and when the exhaust valve is closed fluid may not pass from the exhaust conduit through the exhaust valve. The assembly further comprises a one-way valve located between the first source conduit and the second source conduit, the one-way valve not permitting flow between the first and second source conduits unless the pressure in the first source conduit is higher than the pressure in said second source conduit creating a first pressure differential therebetween and the first pressure differential exceeds a predetermined level, wherein when the first pressure differential exceeds a predetermined level the one-way valve permits fluid to flow from the first source conduit to the second source conduit.

The exhaust valve is operatively connected to the first source conduit, and remains open unless the pressure in the first source conduit is sufficiently higher than the pressure in the exhaust conduit creating a second pressure differential therebetween and the second pressure differential exceeds a predetermined level. For example, if the second pressure differential is great enough to inflate a bladder or dilate a diaphragm situated in the exhaust valve, the passage of gases through the exhaust valve will be blocked.

In one embodiment, the predetermined levels of the pressure differentials between the first and second source conduits and between the first conduit and the exhaust conduits to open the valves are determined by the force with which the flap of the one-way valve is pressed against its seat, and the force with which the bladder of the exhaust valve resists inflation. The resiliency or elasticity and thickness of the materials used can be adjusted in one embodiment. In another embodiment, spring-biased levers or bellows may be used in the one-way and exhaust valves, respectively. Threaded bias adjustors may be used so that spring tension can be adjusted by turning a screw or worm gear. In one embodiment, the resiliency and thickness of the material forming the exhaust valve are adjusted to optimize PEEP or CPAP.

In a preferred embodiment, the valve assembly includes a by-pass conduit in fluid communication with the first source conduit and operatively connecting the first source conduit with the exhaust valve. Preferably, the exhaust valve is closed when the one-way valve permits flow from the first source conduit to the second source conduit, and the exhaust valve is open when the one-way valve is closed.

Thus there are provided new respiratory devices that enable patients in all phases of respiratory care to take advantage of the revolution in ventilation devices and methods brought about by the UNIVERSAL F® and the UNIVERSAL F2®, such as those devices made available by King System Corporation of Noblesville, Ind. Patients may utilize the same mask and co-axial circuit and filter from an emergency medicine situation, through transport in an ambulance, treatment in a hospital operating room, various transport stages in the hospital, and through recovery. This provides improved protection and safety for both the patient and the health care providers. Patient safety is further enhanced by the ability of the co-axial filters or other fittings to readily connect to and disconnect from other compatible systems or kit parts.

New methods of supplying resuscitation devices and assisted ventilation devices and components are hereby provided. For example, co-axial valve assemblies may be distributed, at a profit, at cost, or at no cost in certain circumstances, to various end users for placement in locations of ready accessibility, such as but not limited to paramedics, rescue agencies, ambulance companies, clinics, schools, airlines, office buildings, bus companies, trains, stadiums, doctors' offices, and hospitals. Such valve assemblies may be either disposable after a single use or designed for reuse depending on the consumer.

The valve assemblies may be provided in kits with other components, or kits may be sold separately from the valve assemblies and include various components likely to be required by end users. Kits may include masks, for example laryngeal masks, circuits, filters, tubing, such as orolaryngeal and endotracheal tubes, mouthpieces, and/or breathing bags. Optionally, the kits may include other first aid supplies, such as bandages, tape, antibiotic salve, etc.

In one embodiment, ambulances and/or end users are each supplied with one or more co-axial valves, which may be single use or reusable, and kits containing the necessary components to provide resuscitation or assisted ventilation. In one embodiment, the first few disposable kits may be provided free along with the first few co-axial valve assemblies to encourage use and to familiarize the end users with the advantages of the system. Thereafter, kits for use with the non-rebreathing valves are supplied in sufficient amounts to maintain an inventory capable of meeting end user demand.

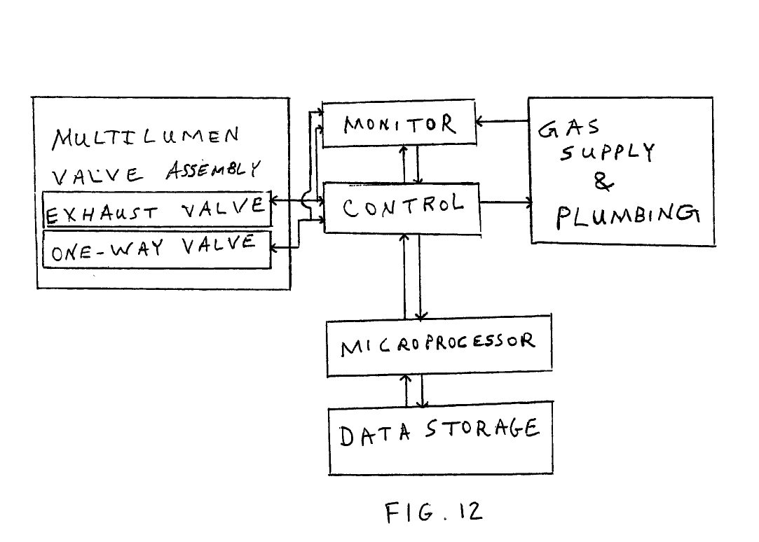

With reference to FIG. 12, the versatility and benefits of the multilumen, e.g., co-axial, valve assemblies of the present invention can be incorporated into an automated device for providing assisted and controlled ventilation. In this embodiment, the exhaust valve does not require a shunt or by-pass conduit to connect it with the source conduit, although this is optional. The exhaust and one-way valves are both operatively connected to a Monitor device, which determines their open or closed status, and to a Control device, which can either directly or indirectly close or open the valves. In a preferred embodiment, the Control device can independently and directly open and close each valve in accordance with preset algorithms in response to data from the monitor device. The data from the monitor can be fed to a Microprocessor, which utilizes programmed algorithms to process the data. Data and programming can be stored and retrieved from a Data Storage device. The Control can automatically and/or semi-automatically adjust gas supply, plumbing arrangements, and breathing cycles. By monitoring pressures in the gas lines and valve status, the automated device can also be synchronized with the patient's spontaneous breathing efforts.

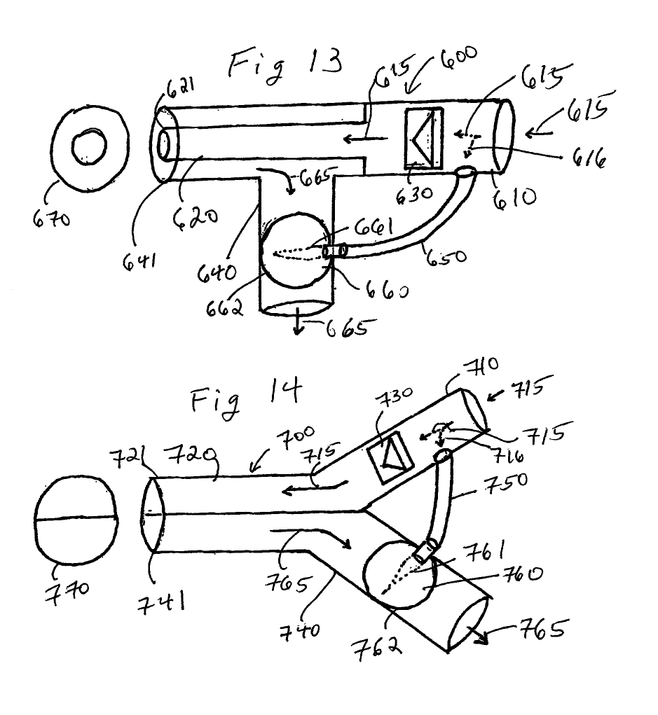

With reference to FIG. 13, an alternative valve assembly 600 of the present invention is illustrated in plan view. A first source conduit 610 is connected to second source conduit 620, with flow therebetween regulated by one-way or check valve 630. Exhaust conduit 640 has a distal portion 641 that surrounds and is co-axial with the distal portion 621 of second source conduit 620. Thus, the valve assembly in FIG. 13 may be referred to as a co-axial F-Valve™, co-axial multilumen valve, or co-axial valve assembly. Fluid may flow to and pass through one-way valve 630 only in the direction of arrows 615 when the pressure in first source conduit 610 exceeds that of second source conduit 620. Fluid may flow into shunt 650 as shown by arrow 616. A shunt 650 operatively connects first source conduit 610 to an exhaust valve bladder 660 located in exhaust conduit 640. Dotted line 661 illustrates the dimensions of bladder 660 when not inflated. Solid line 662 illustrates fully inflated bladder 660. When bladder 660 is not inflated, gas may flow out of exhaust conduit 640 in the direction of arrows 665. When bladder 660 is inflated to its fully inflated form 662, it blocks exhaust conduit 640. Bladder 660 is inflated when pressure in first source conduit 610 exceeds the pressure surrounding bladder 660. Co-axial multilumen valve 600 may be connected at its distal end to co-axial tube 670 shown in end view, or to a fitting of appropriate matching configuration.

With reference to FIG. 14, an alternative valve assembly 700 of the present invention is illustrated in plan view. A first source conduit 710 is connected to second source conduit 720, with flow therebetween regulated by one-way or check valve 730. Exhaust conduit 740 has a distal portion 741 that shares a common wall with distal portion 721 of second source conduit 720. Thus, the valve assembly in FIG. 14 may be referred to as a dual lumen F-Valve™ or a dual lumen or multilumen valve. A shunt 750 operatively connects first source conduit 710 to an exhaust valve bladder 760 located in exhaust conduit 740. Dotted line 761 illustrates the dimensions of bladder 760 when not inflated. Solid line 762 illustrates fully inflated bladder 760. When bladder 760 is not inflated, gas may flow out of exhaust conduit 740 in the direction of arrows 765. When bladder 760 is inflated to its fully inflated form 762, it blocks exhaust conduit 740. Bladder 760 is inflated when pressure in first source conduit 710 exceeds the pressure surrounding bladder 760. Flow lines 715 and 716 are analogous to flow lines 615 and 616. Dual lumen valve 700 may be connected at its distal end to dual lumen tube 770 shown in end view, or to a fitting of appropriate matching configuration.

While exemplary embodiments of the present invention have been set forth above, it is to be understood that the pioneer inventions disclosed herein may be constructed or used otherwise than as specifically described.

1. A co-axial valve assembly for use in a resuscitation or assisted ventilation device, comprising:
a first source conduit, a second source conduit, an exhaust conduit, a one-way valve, and an exhaust valve in said exhaust conduit, wherein at least a portion of said second source conduit is contained within and is co-axial with said exhaust conduit, said one-way valve only permits flow from said first source conduit to said second source conduit, and said exhaust valve is operatively connected to said first source conduit and said one-way valve, wherein said exhaust valve is open when said one-way valve is closed, and said exhaust valve is closed when said one-way valve is open.

2. The valve assembly of claim 1, further comprising:
a by-pass conduit in fluid communication with said first source conduit, wherein said exhaust valve is operatively connected to said first source conduit and said one-way valve via said by-pass conduit.

3. The valve assembly of claim 1, further comprising:
a converter valve in operative relationship with said exhaust conduit and said second source conduit, wherein said converter valve may be adjusted to provide for co-axial flow distal and proximal of said converter valve or to provide for mono-axial flow distal and co-axial flow proximal of said converter valve.

4. The valve assembly of claim 2, wherein said exhaust valve further comprises:
a first barrier selected from the group consisting of a bladder, a resilient flap, a spring biased flange, and a diaphragm, said first barrier being in operative connection with said by-pass conduit, wherein said barrier closes said exhaust valve in response to a sufficient pressure differential between the pressure in said first source conduit and the pressure in said exhaust conduit.

5. The valve assembly of claim 4, wherein said one-way valve comprises a second barrier biased against a seat, said barrier selected from the group consisting of a resilient flap and a spring biased flange, wherein said second barrier can be unseated to permit flow from said first source conduit to said second source conduit upon the pressure in said first source conduit being sufficiently greater than the pressure in said second source conduit.

6. The valve assembly of claim 1, further comprising:
a component selected from the group consisting of a mouthpiece, a breathing bag, and an assisted ventilation machine, said component being coupled to the proximal end of said first source conduit, and
a co-axial filter, said filter being coupled to the distal end of said second source conduit and said exhaust conduit.

7. A valve assembly for use in a resuscitation or assisted ventilation device, comprising:
a first source conduit, a second source conduit, an exhaust conduit, and an exhaust valve operatively connected to said exhaust conduit, said exhaust conduit providing a flow path separate from said first and second source conduits, said exhaust valve capable of opening and closing, wherein when said exhaust valve is open fluid may pass from said exhaust conduit through said exhaust valve to exhaust outside of said exhaust conduit, and when said exhaust valve is closed fluid may not pass from said exhaust conduit through said exhaust valve, and further comprising a one-way valve located between said first source conduit and said second source conduit, said one-way valve not permitting flow between said first and second source conduits unless the pressure in said first source conduit is higher than the pressure in said second source conduit creating a first pressure differential therebetween and said first pressure differential exceeds a predetermined level, wherein when said first pressure differential exceeds a predetermined level said one-way valve permits fluid to flow from said first source conduit to said second source conduit, and
wherein said exhaust valve is operatively connected to said first source conduit, said exhaust valve remains open unless the pressure in said first source conduit is higher than the pressure in said exhaust conduit creating a second pressure differential therebetween and said second pressure differential exceeds a predetermined level.

8. The valve assembly of claim 7, further comprising:
a by-pass conduit in fluid communication with said first source conduit and operatively connecting said first source conduit with said exhaust valve.

9. The valve assembly of claim 8, wherein said exhaust valve is closed when said one-way valve permits flow from said first source conduit to said second source conduit, and said exhaust valve is open when said one-way valve is closed.

10. A method of providing resuscitation or assisted ventilation, comprising:
providing resuscitation or assisted ventilation to a patient in need thereof by use of an apparatus comprising a valve assembly, comprising:
a first source conduit, a second source conduit, an exhaust conduit, a one-way valve, and an exhaust valve in said exhaust conduit, said exhaust conduit providing a flow path separate from said first and second source conduits, wherein said one-way valve only permits flow from said first source conduit to said second source conduit, and said exhaust valve is operatively connected to said first source conduit and said one-way valve, wherein said exhaust valve is open when said one-way valve is closed, and said exhaust valve is closed when said one-way valve is open.

11. The method of claim 10, wherein said valve assembly further comprises:
a by-pass conduit in fluid communication with said first source conduit, wherein said exhaust valve is operatively connected to said first source conduit and said one-way valve via said by-pass conduit, wherein the patient is provided inspiratory gases when said one-way valve is open, and the patient may exhaust expiratory gases when said one-way valve is closed, and said exhaust valve is open.

12. The valve assembly of claim 1, further comprising:
a component selected from the group consisting of a mouthpiece, a breathing bag, and an assisted ventilation machine, said component being capable of releasable coupling to the proximal end of said first source conduit, and
a co-axial filter, said filter being capable of releasable coupling to the distal end of said second source conduit and said exhaust conduit.

13. The valve assembly of claim 12, further comprising:
a mask, and tubing, said tubing being selected from the group consisting of mono-axial tubing and co-axial tubing, wherein said mask may be placed in releasable operative connected with said co-axial valve assembly.

14. The valve assembly of claim 7, further comprising:
a component selected from the group consisting of a mouthpiece, a breathing bag, and an assisted ventilation machine, said component being capable of releasable coupling to the proximal end of said first source conduit, and
a filter, said filter being capable of releasable coupling to the distal end of said second source conduit and said exhaust conduit.

15. The valve assembly of claim 14, further comprising:
a mask, and tubing, said tubing being selected from the group consisting of mono-axial tubing and dual lumen tubing, wherein said mask may be placed in releasable operative connected with said valve assembly.

16. An automated assisted ventilation device, comprising:
a valve assembly, comprising:
a first source conduit, a second source conduit, an exhaust conduit, a one-way valve, and an exhaust valve in said exhaust conduit, wherein said one-way valve only permits flow from said first source conduit to said second source conduit, and said exhaust valve is operatively connected to said one-way valve, wherein said exhaust valve is open when said one-way valve is closed, and said exhaust valve is closed when said one-way valve is open,
said system further comprising a monitor, a control, and a gas supply
said exhaust valve and one-way valve being operatively connected to said monitor and said control, wherein said monitor determines the open or closed status of said valves, and said control operates said valves to open and close in a predetermined fashion to provide gas from said gas supply to said second source conduit and to permit gas to flow from said exhaust conduit through said exhaust valve.

17. The automated assisted ventilation device of claim 16, further comprising:
a data storage device and a microprocessor in operative connection with said control, said monitor, and said gas supply, said data storage device capable of storing algorithms and patient data for use in providing assisted ventilation in a predetermined fashion, and said microprocessor capable of applying said algorithms to data received from said monitor to provide instructions to said control, said control operating said exhaust valve, said one-way valve and said gas supply in response to instructions from said microprocessor.

18. The automated assisted ventilation device of claim 16, wherein at least a portion of said second source conduit is contained within and is co-axial with said exhaust conduit.

19. The valve assembly of claim 1, further comprising: a conversion coupling in operative relationship with said second source conduit and said exhaust conduit, wherein said conversion coupling may be used to provide for mono-axial flow distal and co-axial flow proximal of said conversion coupling.

20. The valve assembly of claim 1, wherein said exhaust valve further comprises a third barrier biased against a seat, said barrier selected from the group consisting of a resilient flap and spring biased flange, wherein said third barrier can be adjusted for controlling at least one of the group consisting of positive end expiratory pressure, and continuous positive airway pressure.
